(19) United States
(12) Patent Application Publication
(10) Pub. No.: US 2018/0108169 A1
(43) Pub. Date: Apr. 19, 2018

(54) IMAGE RENDERING APPARATUS AND METHOD

(71) Applicant: Toshiba Medical Systems Corporation, Otawara-shi (JP)

(72) Inventor: David MILLER, Edinburgh (GB)

(73) Assignee: Toshiba Medical Systems Corporation, Otawara-shi (JP)

(21) Appl. No.: 15/293,818

(22) Filed: Oct. 14, 2016

(51) Int. Cl. G06T 15/08; G06T 7/00; G06F 3/0484

(52) U.S. Cl. CPC G06T 15/08; G06T 7/0012; G06F 3/04845; G06T 2207/20104; G06T 2210/41; G06F 3/04847; G06T 2207/10081; G06T 7/0083

(57) ABSTRACT

A medical image rendering apparatus comprises processing circuitry configured to: display a first image rendered from a volumetric imaging data set, wherein the first image comprises a plurality of pixels; receive a changed value for a parameter associated with a volumetric region of the volumetric imaging data set; obtain a subset of the plurality of pixels, the subset comprising pixels corresponding to rays that intersect the volumetric region of the volumetric imaging data set; re-render each pixel of the subset of pixels by casting a respective ray into the volumetric imaging data set using the changed value for the parameter; and generate a second image in which pixels of the first image that are not part of the subset of pixels are retained, and pixels of the first image that are part of the subset of pixels are replaced by the re-rendered pixels.

### FIELD

Embodiments described herein relate generally to a method of, and apparatus for, rendering of image data, for example targeted re-rendering of a portion of an image during object modification.

### BACKGROUND

It is known to render images from volumetric imaging data, for example from volumetric medical imaging data. A set of volumetric imaging data may be referred to as an image volume. The set of volumetric imaging data may comprise a plurality of voxels with associated intensities, with each voxel being representative of a corresponding spatial location in a medical imaging scan.

Clinicians or other users often define portions of an image volume, for example by selecting a part of a displayed image. The portions of the image volume may be referred to as objects. Objects may represent anatomical structures such as vessels or organs, pathological structures such as tumors, or implanted structures such as stents or pacemakers. In some cases, objects may be defined by using an automated segmentation method to segment particular structures in the image volume.

Objects may be defined for the purposes of changing the appearance of specific clinical anatomy or pathology represented by the objects, for removing clinical anatomy or pathology represented by the objects from the image, or for measuring the clinical anatomy or pathology represented by the objects.

A clinician may define an object in a rendered image, for example by drawing a boundary of the object. Alternatively, the clinician may select an object that has already been defined, for example by automated segmentation.

In some circumstances, a clinician may identify an object in an image volume for the purpose of changing its appearance in a rendered image. For example, the clinician may not be happy with the definition of, or the appearance of, the object in the rendering image and may wish to change the object's color, opacity or size, or another parameter of the object.

Defining an object and/or changing a parameter associated with that object may be performed using 3D volume rendered (VR) views, and may often be performed interactively. An interactive change may mean that a change is made to a parameter, a result of that change is observed (for example, by viewing an updated rendered image), an adjustment to the parameter is made based on the observation, and the process of changing the parameter is repeated until the object is considered to be correctly defined.

In one simple example, on viewing a rendered image, a clinician or other user may wish to change the color of an object that is representative of an organ. The clinician may indicate a change in color, for example by selecting a color on a color palette. An image may be rendered in which the object representative of the organ is rendered with the changed color. The clinician may then change the color again based on how the organ appears with the changed color in an updated rendered image.

In a further example, a clinician may wish to segment an organ, for example the heart. The clinician may click on the heart in a rendered image to request the system to segment the heart, for example by applying upper and lower intensity thresholds and finding voxels within these thresholds that are connected to the clicked point and to each other. The system may display an image in which the heart is segmented. On viewing the segmented heart, the clinician may decide that she wishes to change a parameter used in the segmentation process, for example to change the upper intensity threshold. The clinician may change the parameter, for example, by turning a dial or moving a slider. The system may then re-render the image with the new segmentation. The clinician may continue to adjust the threshold until she is satisfied with the segmentation.

At present, volume rendering views may be slow to render. Therefore, when a clinician is interactively defining or adjusting an object, she may adjust a parameter too much or too little. She may adjust the parameter too much or too little because she is not getting feedback quickly enough. For example, in some known systems, images are rendered at 10 frames per second. A clinician may move a slider or dial so quickly that the image rendering is unable to keep up. The rendering may lag behind the movement performed by the clinician. The lag in rendering may frustrate the clinician. The lag in rendering may mean that she takes longer to define or adjust the object in the way that she wants.

One example of slowness of rendering that has been observed is a slowness of rendering in relation to interactive dilation of objects in a volume rendering view.

The issue of volume rendering not keeping up with real time interactive adjustments made by the clinician may get worse if the volume rendering view becomes slower. As volume sizes increase and as monitor sizes increase, volume rendering views may get slower. Both volumes and monitor sizes are increasing, so the issue of volume rendering not keeping up with interactive adjustments may become increasingly relevant in current systems.

### BRIEF DESCRIPTION OF DRAWINGS

Embodiments are now described, by way of non-limiting example, and are illustrated in the following figures, in which:

FIG. 1 is a schematic diagram of an apparatus according to an embodiment;

FIG. 2 is a flow chart illustrating in overview a method according to an embodiment;

FIG. 3 is a flow chart illustrating in overview a rendering method according to an embodiment;

FIG. 4a is a schematic illustration of an object before dilation;

FIG. 4b is a schematic illustration of the object after dilation;

FIG. 5a is a schematic illustration of a mask corresponding to the object;

FIG. 5b is a schematic illustration of a set of re-rendered pixels corresponding to the object; and

FIG. 6 is a flow chart illustrating in overview a rendering method according to an embodiment.

### DETAILED DESCRIPTION

Certain embodiments provide a medical image rendering apparatus comprising processing circuitry configured to: display a first image rendered from a volumetric imaging data set, wherein the first image comprises a plurality of pixels; receive a changed value for a parameter associated with a volumetric region of the volumetric imaging data set; obtain a subset of the plurality of pixels, the subset comprising pixels corresponding to rays that intersect the volumetric region of the volumetric imaging data set; re-render each pixel of the subset of pixels by casting a respective ray into the volumetric imaging data set using the changed value for the parameter; and generate a second image in which pixels of the first image that are not part of the subset of pixels are retained, and pixels of the first image that are part of the subset of pixels are replaced by the re-rendered pixels.

Certain embodiments provide a medical image rendering method comprising: displaying a first image rendered from a volumetric imaging data set, wherein the first image comprises a plurality of pixels; receiving a changed value for a parameter associated with a volumetric region of the volumetric imaging data set; obtaining a subset of the plurality of pixels, the subset comprising pixels corresponding to rays that intersect the volumetric region of the volumetric imaging data set; re-rendering each pixel of the subset of pixels by casting a respective ray into the volumetric imaging data set using the changed value for the parameter; and generating a second image in which pixels of the first image that are not part of the subset of pixels are retained, and pixels of the first image that are part of the subset of pixels are replaced by the re-rendered pixels.

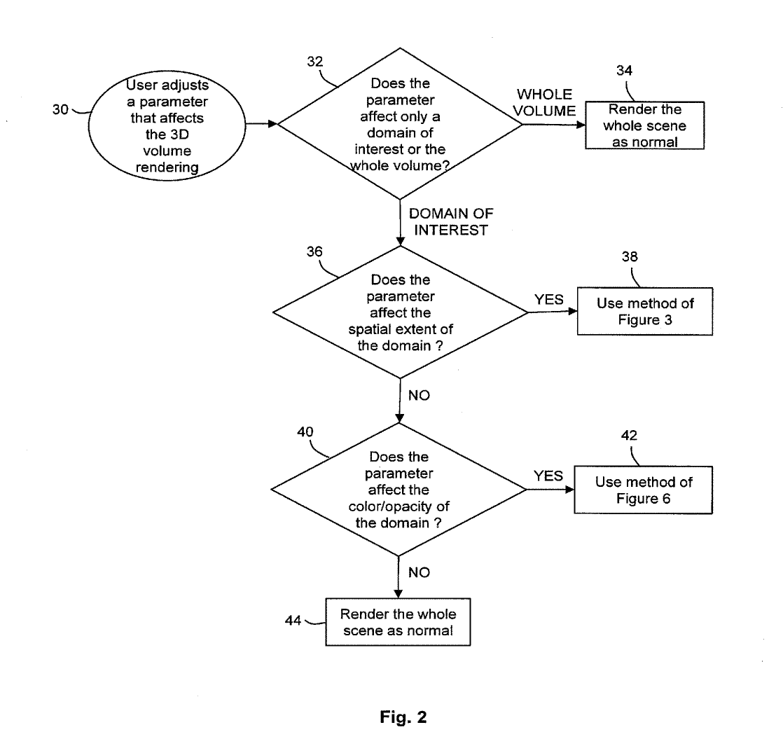

An image rendering apparatus 10 according to an embodiment is illustrated schematically in FIG. 2. The image rendering apparatus 10 comprises a computing apparatus 12, which in this case is a personal computer (PC) or workstation. The computing apparatus 12 is connected to a CT scanner 14, a display screen 16 and an input device or devices 18, such as a computer keyboard and mouse.

In other embodiments, the CT scanner 14 may be supplemented or replaced by a scanner in any appropriate imaging modality, for example a cone-beam CT scanner, MRI (magnetic resonance imaging) scanner, X-ray scanner, PET (position emission tomography) scanner, SPECT (single photon emission computed tomography) scanner, or ultrasound scanner.

In the present embodiment, sets of volumetric imaging data are obtained by the CT scanner 14 and stored in data store 20. In other embodiments, sets of image data may be obtained by any suitable scanner and stored in data store 20. In further embodiments, the image rendering apparatus 10 is not connected to a scanner.

The image rendering apparatus 10 receives sets of volumetric imaging data from data store 20. In alternative embodiments, the image rendering apparatus 10 receives sets of volumetric imaging data from a remote data store (not shown) which may form part of a Picture Archiving and Communication System (PACS).

Computing apparatus 12 provides a processing resource for automatically or semi-automatically processing volumetric imaging data sets. Computing apparatus 12 comprises a central processing unit (CPU) 22.

The computing apparatus 12 includes input circuitry 23 configured to process user input data, decision circuitry 24 configured to decide on a rendering method and rendering circuitry 26 configured to render volumetric imaging data.

In the present embodiment, the circuitries 23, 24, 26 are each implemented in computing apparatus 12 by means of a computer program having computer-readable instructions that are executable to perform the method of the embodiment. However, in other embodiments, the various circuitries may be implemented as one or more ASICs (application specific integrated circuits) or FPGAs (field programmable gate arrays).

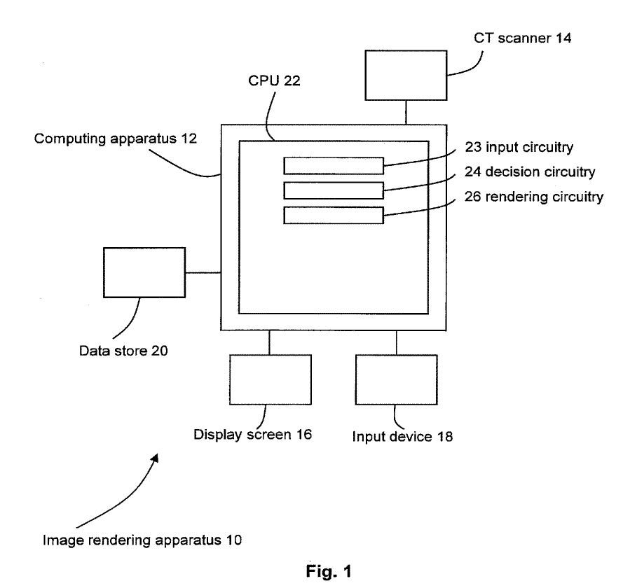

The computing apparatus 12 also includes a hard drive and other components of a PC including RAM, ROM, a data bus, an operating system including various device drivers, and hardware devices including a graphics card. Such components are not shown in FIG. 1 for clarity.

The apparatus of FIG. 1 is configured to perform a series of stages as illustrated in overview in the flow charts of FIGS. 2, 3 and 6.

The computing apparatus 12 receives a volumetric imaging data set from data store 20. In further embodiments, the computing apparatus 12 receives the volumetric imaging data set from a remote data store, or directly from the scanner 14.

In the present embodiment, the volumetric imaging data set is representative of an anatomical region of a patient in which a vessel has been segmented. An object representative of the vessel has been defined in the volumetric imaging data set. In other embodiments, an object in the volumetric imaging data set may represent any appropriate structure which may be an anatomical structure, (for example, a vessel or organ), pathological structure (for example, a tumor) or implanted structure (for example, a stent or a pacemaker). For simplicity, only one object in the volumetric imaging data set is discussed in the embodiment described below. However, in other embodiments a plurality of objects may be defined in a single volumetric imaging set, with each object representing a different structure.

The rendering circuitry 26 renders a first two-dimensional image from the volumetric imaging data set using a ray-casting method. The first image comprises a plurality of pixels, for example a plurality of pixels corresponding to pixels of display screen 16. Any suitable ray-casting method may be used. A ray-casting method may be a method in which image parameter values (for example color and opacity values) are composited along each of a plurality of sample paths. In other embodiments, any suitable rendering method may be used to render the first image, which may or may not comprise ray-casting. For example, the first image may be rendered using shear-warp rendering.

In the present embodiment, the rendering circuitry 26 defines a direction of rendering, for example by defining a viewpoint. The rendering circuitry 26 casts a plurality of rays from the direction of rendering into the volume represented by the volumetric imaging data set. Each ray corresponds to a respective pixel of the first image. The first image may be considered to be formed on an 2D image plane that is perpendicular to the direction in which the rays are cast into the volume. Each pixel occupies a respective position on the 2D image plane, from which its corresponding ray is cast.

For each ray, the rendering circuitry 26 combines parameter values of sample points lying at intervals along that ray to obtain a color value for the pixel corresponding to that ray. The sample points may correspond to, or be interpolated from, voxels of the volumetric imaging data set. The parameter values of the sample points may comprise color and/or opacity values. The color values for the pixels may therefore depend on color and/or opacity values associated with each of the sample points.

In the description of the embodiments below, the sample points are taken to be voxels for simplicity of description. In other embodiments, any suitable sample points may be used which may or may not be voxels. Parameter values for sample points may be obtained by interpolating or otherwise processing voxel parameter values.

The rendering circuitry 26 displays the first image to a user on display screen 16. The user, in response to viewing the first image, may wish to change the image that she is viewing in some way. For example, the user may wish the object (which in this embodiment is representative of a vessel) to be rendered using a different color and/or opacity from those used in rendering the object in the first image. The user may wish to make a change to the spatial extent of the object. For example, the user may consider that an initial segmentation of the vessel has omitted voxels representative of part of the vessel from the defined object. The user may wish to dilate the object so as to obtain a segmentation that the user considers to better represent the vessel.

At stage 30 of the flow chart of FIG. 2, the user adjusts a parameter that affects the 3D volume rendering. The parameter may comprise, for example, a color or opacity, or a segmentation parameter, or a viewpoint. In some embodiments, the first image has been rendered using an image preset, and the user changes one of the parameters of the preset. In some embodiments, the user changes from a first preset to second preset.

In the present embodiment, the user provides a user input to the computing apparatus 12 via input device 18. For example, the user may type in information, or adjust a slider, dial or other input device. The slider, dial, or other input device may be implemented in hardware or in software. In other embodiments, the user may provide the user input via any suitable user interface.

The input circuitry 23 processes the user input to obtain a value for a parameter and passes the value for the parameter to the decision circuitry 24. If the value for the parameter that is obtained from the user input is different from the value for that parameter that was used in rendering the first image, the decision circuitry 24 proceeds to stage 32 of FIG. 2.

At stage 32, the decision circuitry 24 determines whether the parameter that has been adjusted by the user is a parameter that affects only a domain of interest, or a parameter that affects the whole volume. A parameter that affects only a domain of interest may be a parameter that affects a proportion of the volumetric imaging data set, and does not affect a further proportion of the volumetric imaging data set.

For example, if the user adjusts a parameter that relates to only one object (for example, the object representative of the vessel), and that object is small compared to the entire volumetric imaging data set, the decision circuitry 24 may determine that the parameter affects only a domain of interest. Examples of such parameters may include rendering parameters relating to individual objects, for example a color or opacity of a particular object.

If the user adjusts a parameter that relates to the whole of the volumetric imaging data set, the decision circuitry 24 may determine that the parameter affects the whole volume. Such parameters may include for example, a viewpoint from which the image is rendered, a scale at which the image is rendered, a lighting level of the entire scene shown in the image, or a contrast level of the entire scene shown in the image.

If the decision circuitry 24 determines that the parameter affects the whole volume, the process of FIG. 2 proceeds to stage 34.

In further embodiments, the decision circuitry 24 may determine a proportion of the volume that is affected by the change to the parameter, and may proceed to stage 34 if it determines that the change to the parameter affects a proportion of the volume that is greater than a threshold proportion, for example if the change to the parameter affects more than 10%, 20% or 50% of the volume. In other embodiments, the decision circuitry 24 may use any appropriate criterion to determine whether to proceed to stage 34.

At stage 34, the rendering circuitry 26 re-renders the volumetric imaging data set to obtain a second image. The rendering circuitry 26 re-renders each pixel of the plurality of pixels using the changed value for the parameter. In the present embodiment, for each pixel of the plurality of pixels, the rendering circuitry 26 casts a ray into the volume represented by the volumetric imaging data set, and obtains a color for the pixel by combining parameter values for voxels along that ray. The rendering circuitry 26 displays the second image, in which every pixel has been re-rendered.

If at stage 32 the decision circuitry 24 determines that the parameter affects only a domain of interest (for example, the object), the process of FIG. 2 proceeds to stage 36.

At stage 36, the decision circuitry 24 determines whether the parameter adjusted by the user affects the spatial extent of the domain of interest. For example, the user may have adjusted a segmentation parameter that changes the spatial extent of an object, for example expanding the object, reducing the object, or changing the shape of the object.

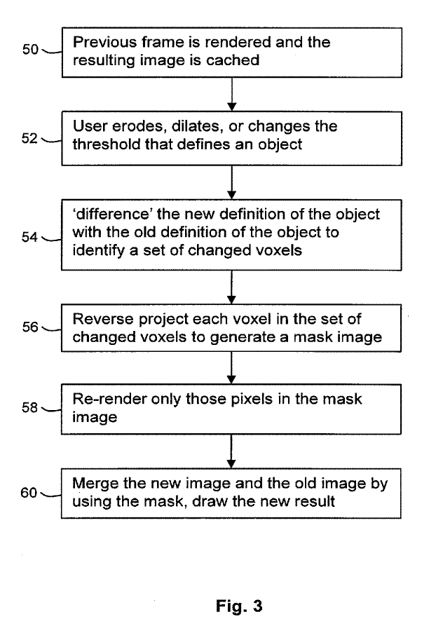

If the decision circuitry 24 determines that the parameter adjusted by the user affects the spatial extent of the domain of interest, the process of FIG. 2 proceeds to stage 38. At stage 38, the rendering circuitry 26 renders a second image from the volumetric imaging data set using the method described below with reference to FIG. 3.

If at stage 36 the decision circuitry 24 determines that the parameter adjusted by the user does not affect the spatial extent of the domain of interest, the process of FIG. 2 proceeds to stage 40.

At stage 40, the decision circuitry determines whether the parameter adjusted by the user affects a color and/or opacity of the domain of interest. For example, if the domain of interest is an object, the user may have adjusted a color in which the object is to be rendered. Examples of values for parameters affecting color and/or opacity may include rendering parameters such as RGB or HSL parameters, opacity, transparency or absorption. In other embodiments, the adjusted parameter may comprise any rendering parameter which may or may not affect color and/or opacity.

In other embodiments, the decision circuitry 24 may determine whether the parameter adjusted by the user is any rendering parameter that affects the rendering of a domain of interest (for example, an object) without affecting the spatial extent of the domain of interest.

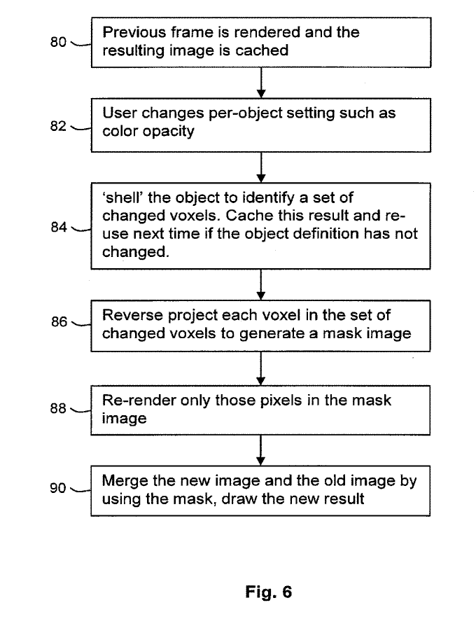

If the decision circuitry 24 determines that the parameter adjusted by the user affects the color and/or opacity of the domain of interest, the process of FIG. 2 proceeds to stage 42. At stage 42, the rendering circuitry renders a second image from the adjusted imaging data set using the method described below with reference to FIG. 6.

If at stage 40 the decision circuitry 24 determines that the parameter adjusted by the user does not affect the color and/or opacity of the domain of interest, the process of FIG. 2 proceeds to stage 44.

At stage 44, the rendering circuitry 26 renders the volumetric imaging data set using the adjusted parameter to obtain a second image. In the present embodiment, the rendering method used at stage 44 is the same as the rendering method used at stage 34. For every pixel of the plurality of pixels, the rendering circuitry 26 casts a ray into the volume represented by the volumetric imaging data set, and obtains a color for the pixel by combining parameter values (for example color and/or opacity values) for voxels along that ray. In other embodiments, any suitable rendering method or methods may be used for each of stage 34 and stage 44.

In other embodiments, the decision circuitry 24 may use a different decision-making process from the one described above with reference to FIG. 2. For example, the decision circuitry 24 may use a different set of decisions from those detailed in FIG. 2, or may use a different ordering of decisions. Any suitable decision-making process may be used.

FIG. 2 applies to the selection of a rendering method for a single image (the second image) based on which parameter is changed by the user, in particular how that parameter affects a domain of interest.

In other embodiments, some of which are described below, the decision circuitry 24 selects a rendering method based on the parameter adjusted by the user but also on a time taken for the rendering or one or more previous images using one or more of the possible rendering methods (for example, the rendering methods of stages 34, 38, 42 or 44).

FIG. 2 relates to an embodiment in which only one parameter is changed by a user, the one parameter relating either to a single object or to the entire scene. In further embodiments, the user input may result in a change to more than one parameter. The decision circuitry 24 may make decisions based on any one or more of the changed parameters. For example, the decision circuitry 24 may decide on a rendering method based on whether any of the parameters affect the whole volume, or whether any of the parameters affect the spatial extent, color or opacity.

In some embodiments, changed parameters may affect more than one object. The decision circuitry 24 may decide on a rendering method based on how many objects are affected by the change, or how large a domain of interest is affected by the change. The domain of interest may comprise all changed objects.

Returning to the embodiment of FIG. 2, we turn to the case in which the decision circuitry 24 has determined at that a parameter affects only a domain of interest (at stage 32) and affects the spatial extent of that domain of interest (at stage 36) and therefore the process of FIG. 2 has proceeded to stage 38. At stage 38, the rendering circuitry 26 renders a second image using the process of FIG. 3.

In the second image, the object is shown with its new spatial extent. When the spatial extent of an object is changed, parameters of some of the voxels of the volumetric imaging data set are changed accordingly. Voxels that are part of the object may have particular color and/or opacity values, while voxels that are not part of the object may have different color and/or opacity values from those of the object. The object may be visually distinguished from its surroundings.

When the extent of the object is changed, voxels that change from being part of the object to not being part of the object may change color and/or opacity. Similarly, voxels that change from not being part of the object to being part of the object may change color and/or opacity.

At stage 50 of FIG. 3 the rendering circuitry 26 caches the first image, for example by storing color values (for example, RGB or HSL values) of each pixel of the first image.

At stage 52, the rendering circuitry 26 changes the spatial extent of an object in accordance with the parameter that was adjusted by the user at stage 30 of FIG. 2. The user may erode, dilate or change the threshold that defines an object. The rendering circuitry 26 may assign new values for rendering parameters (for example, new color and/or opacity values) to voxels that are changed due to the change in spatial extent of the object.

In the present embodiment, the object is representative of a vessel. The user provides a user input that indicates that the user wishes to dilate the vessel. The input circuitry 23 processes the user input to obtain a changed value for a dilation parameter, for example a factor by which the vessel is to be dilated.

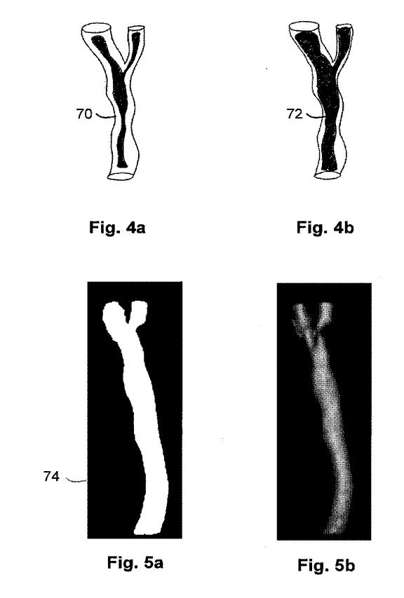

FIGS. 4a and 4b are representative of the dilation of an object 70 that is representative of a vessel. FIG. 4a is a schematic illustration of the object 70 before dilation. FIG. 4b is a schematic illustration of the dilated object 72, which provides an updated representation of the vessel.

The rendering circuitry 26 assigns to all voxels in the dilated object 72 values for at least one rendering parameter that is associated with voxels of vessel. For example, voxels of vessel may be colored red.

In a further embodiment, the user provides an input indicating that the user wishes to erode the object. The input circuitry 23 processes the user input to obtain a changed value for an erosion parameter, for example a factor by which the object is to be eroded. The rendering circuitry 26 erodes the object in accordance with the user's input. The rendering circuitry 26 assigns to all voxels in the eroded object at least one rendering parameter that is associated with voxels of vessel, and assigns to voxels that are not in the eroded object at least one rendering parameter that is associated with voxels that are not vessel.

In other embodiments, the user's input may be indicative of any suitable operation that changes the spatial extent of the object, for example any suitable morphological operation. The rendering circuitry 26 may erode the object, dilate the object, merge the object with another object, or separate an object into a plurality of objects. The rendering circuity 26 may perform a morphological open or morphological close operation. The adjusted parameter may be a segmentation parameter, for example a threshold value used in segmentation. The rendering circuitry 26 may change the segmentation of the object in accordance with the change in the segmentation parameter. The rendering circuitry 26 may assign to the newly segmented object one or more rendering parameters associated with the object.

At stage 54 of FIG. 3, the rendering circuitry 26 obtains a region of the volumetric imaging data set corresponding to a difference between the original object and the object that has been modified to have an adjusted spatial extent (which in the present embodiment is a dilated object). The region may be referred to as a difference region. The difference region comprises voxels that are in one of the original object and the modified object, but are not in the other of the original object or modified object. The difference region comprises voxels for which at least one rendering parameter is changed due to the change in the spatial extent of the object.

In the present embodiment, the rendering circuitry 26 obtains the difference region by subtracting the original object 70 from the modified (dilated) object 72.

In a further embodiment in which the object is eroded, the rendering circuitry 26 obtains the difference region by subtracting the modified (eroded) object from the original object.

In another embodiment, the parameter for which a changed value is obtained is a threshold value used in segmenting the object, for example an upper threshold value or lower threshold value. The threshold value may be an intensity value. The rendering circuitry 26 segments the object using the new threshold value to obtain a modified object having a different segmentation threshold. The modified object may have a different size from the original object. For example, changing the threshold value may result in the object expanding in size, reducing in size, or changing in shape. The rendering circuitry 26 obtains a difference region that comprises voxels that are part of original object but are not part of the modified object and/or voxels that are part of the modified object but are not part of the original object.

In general, the rendering circuitry 26 obtains the difference of a new definition of the object and an old definition of the object to identify a set of changed voxels. By difference it is meant that voxels are found that are in one object (i.e. the original object or the modified object) but not in the other.

At stage 56, the rendering circuitry 26 reverse projects voxels in the difference region onto the 2D image plane from which rays were cast to form the first image. Each voxel in the set of changed voxels is reverse projected to generate a mask image. In embodiments in which the first image was rendered using a method that does not comprise ray casting (for example, the first image was rendered using shear-warp rendering), the rendering circuitry 26 reverse projects voxels onto a 2D image plane that would have been used if the first image had been rendered using ray casting.

Because the change in parameter has not changed the viewpoint, the 2D image plane is not changed. In the present embodiment, the rendering circuitry 26 reverse projects all of the voxels of the difference region. In other embodiments, the rendering circuitry 26 may reverse project a subset of the voxels of the difference region.

The voxels of the difference region are reverse projected in a direction opposite to that of the propagation of rays into the volumetric imaging data set.

The 2D image plane comprises a plurality of pixels, for example pixels corresponding to a screen 16 on which images are displayed. Each voxel of the difference region is reverse projected onto a pixel of the image plane. The pixel onto which the voxel is reverse projected is the pixel from which a ray cast into the volumetric imaging data set would pass through the voxel. Each pixel may be considered to correspond to a respective ray.

In the present embodiment, the object occupies only a small part of the volume of the volumetric imaging data set. The difference region therefore occupies only a small part of the volume of the volumetric imaging data set. When the voxels of the difference region are reverse projected onto the 2D image plane, the reverse projected voxels occupy only a small proportion of the 2D image plane.

The rendering circuitry 26 selects a subset of pixels comprising the pixels onto which voxels of the difference region have been reverse projected. The subset of pixels may be considered to form a mask image. The mask image may be considered to be representative of a reverse projection of the difference region onto the 2D image plane.

Since the voxels are reverse projected onto the 2D image plane in a direction opposite to a direction of ray propagation into the volumetric imaging data set from the image plane, the paths along which the voxels of the difference region are reverse projected correspond to paths of some of the rays. If a ray cast from a given pixel would not intersect the difference region, no voxels of the difference region are reverse projected onto that pixel and that pixel is not included in the subset of pixels. If a ray cast from a given pixel would intersect the difference region, one or more voxels of the difference region is reverse projected onto that pixel and that pixel is included in the subset of pixels.

The subset of pixels includes any pixels for which a ray cast from that pixel would intersect the difference region.

The subset of pixels therefore comprises pixels that may be expected to change color due to the changed value for the parameter. For each pixel of the subset of pixels, a ray cast from that pixel would intersect one or more voxels of the difference region. The calculation of the color of the pixel, which is based on the properties of voxels along the ray, may be affected by a change in the rendering parameter values of one or more voxels along that ray, for example a change in color and/or opacity.

Pixels that are not part of the subset of pixels are expected not to change due to the change in the parameter, because rays cast from pixels that are not part of the subset of pixels do not pass through any changed voxels.

FIG. 5a is representative of a mask image 74 that is generated by reverse projecting voxels of the difference region of original object 70 and modified object 72 as represented in FIGS. 4a and 4b. Since the original object 70 is dilated in three dimensions to form the modified object 72, the difference region comprises a layer of voxels surrounding a boundary of the original object. The projection of the difference region onto the 2D image plane forms a mask image that is somewhat larger than a projection of the original object.

In further embodiments, instead of reverse projecting only the voxels of the difference region, the rendering circuitry 26 reverse projects all of the voxels of the original object, or of the modified object. Whether to reverse project the voxels of the original object or of the modified object may depend on how the spatial extent of the object has been changed. The mask image formed by reverse projecting all of the voxels of the original object or modified object may be the same as a mask image formed by reverse projecting only voxels of the difference region.

At stage 58, the rendering circuitry 26 re-renders each pixel in the subset of pixels that was identified at stage 56. Each pixel is re-rendered by casting a ray into the volumetric imaging data set and combining the parameter values for voxels along the ray, which include the changed parameter values of the voxels in the difference region.

FIG. 5b represents a new image 76 comprising a re-rendered version of the subset of pixels of FIG. 5a. Only those pixels in the mask image 74 are re-rendered.

Stage 58 may be described as a selective re-rendering stage, since only pixels in the subset of pixels are re-rendered, and other pixels (which are not expected to change due to the change in spatial extent) are not re-rendered.

At stage 60, the rendering circuitry 26 generates a second image using the first, cached image, the new image that was rendered at stage 58, and the mask image that was determined at stage 56. The new image comprising the re-rendered pixels of stage 58 is merged with the first, cached image (which may be considered to be an old image) using the mask image. For each pixel that is not part of the subset of pixels, the rendering circuitry 26 uses the cached value of the color value for that pixel from the first image. For each pixel that is part of the subset of pixels, the rendering circuitry 26 uses the color value for that pixel that was obtained by the re-rendering of stage 58.

The rendering circuitry 26 draws the second image, which is the result of merging the new image and the old image by using the mask. The second image is displayed to the user on display screen 16.

A rendering frame rate using the method of FIG. 3 may be faster than a rendering frame rate that may be achieved when re-rendering the entire plurality of pixels. By re-rendering only a subset of the plurality of pixels instead of the entire plurality of pixels, faster performance may be achieved. For example, if the object to be re-rendered is small, the number of pixels to be re-rendered may be much smaller than the total number of pixels.

In some circumstances, reverse-projecting only voxels of the difference region at stage 56 may be faster than reverse-projecting all of the voxels of the object, or of the modified object. Reverse-projecting only the voxels of the difference region may result in a further improvement of rendering frame rate.

In some embodiments, the first image is rendered using a non-ray casting renderer and the subset of the plurality of pixels are then re-rendered using a ray-casting renderer. For example, the first image is rendered using a shear-warp renderer. In some circumstances, a shear-warp renderer may have better performance characteristics than a ray-casting renderer for a full-image render.

Turning again to FIG. 2, we consider the scenario in which the parameter adjusted by the user at stage 30 is determined to affect only a domain of interest (at stage 32), not to affect the spatial extent of the domain (at stage 36), and to affect the color and/or opacity of the domain (at stage 40). In this scenario, the process of FIG. 2 proceeds to stage 42 and the rendering circuitry renders a second image using the process of FIG. 6. In the second image, rendering parameters of the object are changed to cause a change in the appearance of the object when compared with the appearance of the object in the first image.

Stage 80 of FIG. 6 is the same as stage 50 of FIG. 3. The rendering circuitry 26 caches the first image by storing color values (for example, RGB or HSL values) of each pixel of the first image.

At stage 82, the rendering circuitry 26 receives a changed value for color and/or opacity of an object from the input circuitry 23, and changes a per-object setting for the color and/or opacity of the object. The rendering circuitry 26 changes a color and/or opacity associated with each voxel of the object.

At stage 84, the rendering circuitry 26 obtains a region of the volumetric image data set that forms a shell region of the object. In the present embodiment, the rendering circuitry 26 determines the shell region for the object as described below. In other embodiments, the rendering circuitry 26 retrieves a stored (for example, cached) shell region for the object.

In the present embodiment, the shell region of the object is a continuous layer of voxels conforming to an outer boundary of the object. The layer of voxels may be of any suitable thickness, for example 1, 2, 3 or 4 voxels thick. The layer of voxels may comprise voxels on the surface of the object. The layer of voxels may be contained within the object, or may surround the object.

In the present embodiment, the rendering circuitry 26 obtains the shell region by a morphological erosion of the object to obtain an eroded object, followed by a subtraction from the eroded domain (the eroded object) from the original domain (the original object) to obtain the shell region. In other embodiments, any suitable method of obtaining a shell region may be used. The shell region may conform to an entire outer boundary of the object, or a part of the outer boundary of the object (for example, a part of the outer boundary that faces the direction from which the rays are cast).

In some embodiments, the rendering circuitry 26 shells the object to identify a set of changed voxels. The rendering circuitry 26 caches the result of the shelling of the object (i.e. the shell region). The rendering circuitry 26 re-uses the cached result of the shelling next time if the object definition has not changed. The rendering circuitry 26 may use the determined shell region in the rendering of one or more subsequent frames in which the object has the same spatial extent (and therefore the same shell region).

At stage 86, the rendering circuitry 26 reverse projects each voxel of the shell region obtained at stage 84 onto a 2D image plane of the first image that was cached at stage 80. Each voxel in the set of changed voxels is reverse projected to generate a mask image. The reverse projecting of the voxels is similar to the reverse projecting described above with relation to stage 56 of FIG. 3.

The rendering circuitry 26 selects a subset of the pixels of the first image (which may be considered to form the mask image). The selected pixels in the subset each correspond to one or more projected voxels of the shell region.

Stage 86 of FIG. 6 is similar to stage 56 of the process of FIG. 3, but is performed on the shell region obtained at stage 84 instead of being performed on a difference region. In the process of FIG. 6, the spatial extent of the object is not changed, and therefore it is not possible to obtain a difference region as described with reference to FIG. 3.

In other embodiments, the rendering circuitry 26 does not obtain a shell of the object. Stage 84 may be omitted. In such embodiments, at stage 86 the rendering circuitry 26 may reverse projects all of the voxels of the object onto a plane of the first image.

By obtaining the shell of the object, the rendering circuitry 26 may reduce the number of reverse projections used by performing reverse projection only on voxels that are obtained by obtaining a morphological shell of the object. The same subset of pixels may be obtained as would be obtained by reverse projecting the entire object. This is because any ray that passes through a voxel that is in the interior of the object (i.e. not part of the shell region) also passes through the shell region in order to enter the interior of the object. Reverse projecting only voxels in the shell region may reduce the time taken and/or computational power required to select the subset of pixels.

At stage 88, the rendering circuitry 26 re-renders each pixel in the subset of pixels by casting a ray into the volumetric image data set, using the new values for rendering parameters of the voxels of the object that were assigned at stage 84. Only those pixels in the mask image are re-rendered.

At stage 90, the rendering circuitry 26 generates a second image using the first, cached image and the mask image that was determined at stage 86. For each pixel that is not part of the subset of pixels, the rendering circuitry 26 uses the cached value of the color value for that pixel from the first image. For each pixel that is part of the subset of pixels, the rendering circuitry 26 uses the color value for that pixel that was obtained by the re-rendering of stage 88.

The rendering circuitry 26 draws the second image, which is the result of merging the new image and the old image by using the mask. The second image is displayed to the user on display screen 16.

To summarize the processes of FIGS. 2, 3 and 6, when a user is changing a per-object property then the previously rendered image is retained (for example, cached). Portions of the view that are intended to be re-rendered are identified and used to create a mask image. Using a ray-cast renderer and the mask image, the rendering circuitry 26 re-renders only portions of a volume that correspond to the mask. A new final image is produced by compositing together the previously rendered image and the new image, making reference to the mask image to decide what to composite together.

A mechanism may be created that exploits the ray-casting nature of the rendering to achieve interactive performance via targeted re-rendering. Improved performance and interactivity during object modification may be achieved through targeted re-rendering.

By selecting a subset of pixels by reverse projecting a difference region (in the case of the method of FIG. 3) or a shell region (in the case of the method of FIG. 6) onto a plane of the first image, and re-rendering only that selected subset of pixels, re-rendering may in some circumstances be performed more quickly than if all of the pixels in the image were to be re-rendered.

In particular, if a change is made only to an object that occupies only a small part of the first image, considerable time and/or computing power may be saved by only re-rendering the part of the image that has changed (i.e. the subset of pixels) and not re-rendering pixels that are not affected by the change in the object.

The object of interest may be defined by the user and is contained within the volume. The object of interest forms a part of the volumetric imaging data set.

An interactive process may be provided in which changes made by a user (for example, a clinician) are quickly implemented in a rendered image. A time taken to re-render an image may be reduced. A new image may be displayed to a user more quickly. Lag times in rendering may be reduced.

In some circumstances, if a user makes a change to a parameter of a first image, the user may see the image updating in real time or near-real time. Faster image updating may reduce in less time being wasted by the user. Less time may be wasted if the user does not have to wait for rendering to update. Less time may be wasted if the user does not overshoot a parameter adjustment due to rendering not keeping up with the parameter adjustment.

In some circumstances, the user may find the system more convenient and/or efficient to use. The user may find it easier to interact with the system. By only rendering a subset of the scene, the re-rendering may be faster and the user may make fewer mistakes than may be made when the feedback is too slow due to slow re-rendering.

In the method of FIG. 2, the user does not have to select whether or not to re-render an image, or whether or not to re-render a part of the image or a particular object in the image. The decision circuitry 24 decides which rendering method to use automatically based on the parameter changed by the user. The rendering circuitry 26 determines which pixels to re-render based on the parameter that is changed and the object that it affects. In some circumstances, the user may not be aware of whether the entire image is re-rendered or only a part of the image is re-rendered. In some circumstances, interactive performance may be improved without requiring any additional action by the user. The selection of a rendering method may be inferred from a user action without manual action from the user.

Using the method of FIG. 2, the decision circuitry 24 may determine prospectively which differences may be of interest (for example, parameter changes that only affect a limited domain) and may immediately apply the algorithm of FIG. 3 or of FIG. 6 on the next frame to be rendered.

Interactive-level performance may be more valuable in certain use cases than in the general case. The use of the method of FIG. 3 or of FIG. 6 may be based on the user performing an action on a current object, and the action being an action that may benefit from interactive performance. Actions that may benefit from interactive performance may include, for example, erosion, dilation, thresholding, or changes to color or opacity.

The methods described above with reference to FIGS. 2, 3 and/or 6 may be particularly useful where image volumes are large. Large image volumes may in some circumstances lead to slow rendering. In some circumstances, the rendering speed may be improved by using the method of FIGS. 2, 3 and/or 6.

The methods described above with reference to FIGS. 2, 3 and/or 6 may be particularly useful if a large monitor is used (for example, if display screen 16 comprises a large number of pixels).

In some embodiments, features of the method of FIG. 3 may be combined with features of the method of FIG. 6. For example, at stage 54 of the method of FIG. 3, the rendering circuitry 26 may obtain a difference region. The rendering circuitry 26 may then obtain a shell of the difference region as described above with reference to stage 84 of FIG. 6. Any suitable features of the different methods may be combined.

In the embodiment described above with reference to FIG. 2, the decision circuitry 24 selects a rendering method to be used for an individual frame, and a single change of parameter. The decision circuitry 24 selects which rendering method to use based on whether the parameter affects the spatial extent of a domain of interest, and whether the parameter affects the color or opacity of the domain. The method of FIG. 2 may be repeated for successive frames. For example, each time the user makes a change to a parameter, the decision circuitry 24 may perform the method of FIG. 2 to decide which rendering method to use in rendering an updated image.

In other embodiments, a rendering method for a particular frame is selected based on a rendering speed of previous frames.

There may be cases in which a cost of identifying changed voxels, and reverse-projection to identify changed screen pixels, will be higher than the cost of simply re-rendering the whole scene. Therefore the decision circuitry 24 may monitor rendering times to ascertain whether the method of FIG. 3 or FIG. 6 is, or is not, likely to be faster than re-rendering every pixel.

In one embodiment, the decision circuitry 24 is configured to store how long it took the last time a full scene was rendered. For example, in one embodiment, the rendering circuitry 26 renders a first image by rendering every pixel of the image using any appropriate rendering method. The decision circuitry 24 determines and stores a time taken to render the first image. The rendering circuitry 26 renders a second image using the method of FIG. 3. The decision circuitry 24 determines and stores a time taken to render the second image. If the time taken to render the second image is shorter than the time taken to render the first image, the decision circuitry 24 may decide to continue to use the method of FIG. 3 to render subsequent images. If the time taken to render the second image is longer than the time taken to render the first image (for example, because the time taken to identify and reverse-project the changed voxels is longer than a time that is saved by re-rendering only a subset of pixels), then decision circuitry 24 may decide to render subsequent images by re-rendering every pixel.

Similarly, in a further embodiment, the decision circuitry 24 may determine and store a time taken to render a first image by rendering every pixel and determine and store a time taken to render a second image using the method of FIG. 6. The decision circuitry may decide based on the rendering times for the first image and for the second image whether to render a subsequent image by using the method of FIG. 6 or by re-rendering every pixel.

In various embodiments, the decision circuitry 24 may monitor how long it takes to render an image using the method of FIG. 3 and/or the method of FIG. 6 (each of which may be described as an ‘identify and render only the changed screen pixels’ method). The decision circuitry 24 may remember how long it took the last time a full scene was rendered. The decision circuitry 24 may revert to rendering the whole scene if it determines that rendering the whole scene will be faster than using the method of FIG. 3 or FIG. 6. The decision circuitry 24 may continue to render using the method of FIG. 3 or FIG. 6, and may not revert to rendering the whole scene, if it determines that the method of FIG. 3 or FIG. 6 will be faster.

In some circumstances, it may be likely that an ‘identify and render only the changed screen pixels’ method (for example, the method of FIG. 3 or FIG. 6) may be faster than rendering the whole scene for anything other than very large and very complex objects.

In some embodiments, the decision circuitry 24 alternates between rendering methods. For example, in one embodiment a user makes several changes to a parameter that affects the spatial extent of the domain of interest. The rendering circuitry 26 renders several frames using the method of FIG. 3. The decision circuitry 24 instructs the rendering circuitry 26 to render some frames, for example every fifth frame, by re-rendering all of the pixels using any appropriate rendering method. The decision circuitry 24 assesses whether the re-rendering of all pixels is faster than the method of FIG. 3. If so, the decision circuitry 24 may instruct the rendering circuitry 26 to render most subsequent frames using the re-rendering of all pixels, and use the method of FIG. 3 for only some frames, for example every fifth frame. If the method of FIG. 3 becomes faster than re-rendering all pixels, the decision circuitry 24 may revert to rendering most frames using the method of FIG. 3.

In some embodiments, the decision circuitry 24 alternates between a first rendering method that comprises determining and reverse projecting a shell region of the object, and a second rendering method that comprises reverse projecting the entire object. The decision circuitry 24 compares a time taken to render an image in which a shell region is reverse projected, and a time taken to render an image in which the entire object is reverse projected. In some circumstances, the time taken to determine the shell region may be longer than a time saved by not reverse projecting voxels of the interior of the object. If it is faster to reverse project the whole object, the decision circuitry 24 may select the second rendering method for some or all subsequent frames.

In further embodiments, the decision circuitry 24 may decide between a first rendering method that comprises reverse projecting voxels of a difference region, and a second rendering method that comprises reverse projecting voxels of an entire original object or modified object.

In the embodiments described above, the volumetric imaging data set comprises CT data. In other embodiments, the volumetric imaging data set may comprise data of any appropriate modality, for example, cone-beam CT, MRI, X-ray, PET, SPECT or ultrasound data.

The volumetric imaging data set may be representative of any appropriate anatomical region of any human or animal subject. Any suitable ray casting method may be used. Any suitable display system and method may be used. The user may provide input through any suitable user input interface.

The method of FIGS. 2, 3 and 6 may be provided on any suitable image processing apparatus, which may or may not be coupled to a scanner. The apparatus may be used for post-processing data. The data may be stored data.

In certain embodiments, there is provided a medical imaging method comprising: receiving a volumetric medical image data set; defining a domain of interest within the data set; displaying a first rendered image of the data set; receiving user input to adjust parameters affecting the domain of interest; and displaying a second rendered image of the data set, in which the second rendered image re-uses some pixels of the first rendered image.

The parameter adjustment may affect only a domain of interest.

The parameter being adjusted may be one where the effective adjustment will benefit from giving quick feedback to the user (such as, but not limited to, interactive dilation, erosion, thresholding or color/opacity).

A mask image may be constructed by taking the shell of the new domain of interest and reverse-projecting each voxel in the shell to identify affected pixels.

A ray-casting renderer may re-render only those pixels identified in the mask image to a new image.

The new image, the mask image, and the previously rendered image may be composited to produce a new final image.

Whilst particular circuitries have been described herein, in alternative embodiments functionality of one or more of these circuitries can be provided by a single processing resource or other component, or functionality provided by a single circuitry can be provided by two or more processing resources or other components in combination. Reference to a single circuitry encompasses multiple components providing the functionality of that circuitry, whether or not such components are remote from one another, and reference to multiple circuitries encompasses a single component providing the functionality of those circuitries.

Whilst certain embodiments have been described, these embodiments have been presented by way of example only, and are not intended to limit the scope of the invention. Indeed the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms and modifications as would fall within the scope of the invention.

1. A medical image rendering apparatus comprising processing circuitry configured to:
display a first image rendered from a volumetric imaging data set, wherein the first image comprises a plurality of pixels;
receive a changed value for a parameter associated with a volumetric region of the volumetric imaging data set;
obtain a subset of the plurality of pixels, the subset comprising pixels corresponding to rays that intersect the volumetric region of the volumetric imaging data set;
re-render each pixel of the subset of pixels by casting a respective ray into the volumetric imaging data set using the changed value for the parameter; and
generate a second image in which pixels of the first image that are not part of the subset of pixels are retained, and pixels of the first image that are part of the subset of pixels are replaced by the re-rendered pixels.

2. An apparatus according to claim 1, wherein each pixel of the plurality of pixels of the first image is rendered by casting a respective ray into the volumetric imaging data set, and wherein the subset of the plurality of pixels comprises pixels rendered from rays that intersect the volumetric region of the volumetric imaging data set.

3. An apparatus according to claim 1, wherein the volumetric region of the volumetric imaging data set is representative of at least part of at least one of an anatomical structure, a pathological structure, an implanted structure.

4. An apparatus according to claim 1, wherein the obtaining of the subset of the plurality of pixels comprises reverse projecting voxels in the volumetric region onto a two-dimensional plane corresponding to a plane of the first image.

5. An apparatus according to claim 1, wherein the generating of the second image comprises combining the first image and the re-rendered pixels using a mask image corresponding to the subset of pixels.

6. An apparatus according to claim 1, wherein:
the changed value for the parameter is such as to modify a spatial extent of a segmented object in the volumetric imaging data set to obtain a modified object; and
the volumetric region comprises at least part of the segmented object or of the modified object.

7. An apparatus according to claim 6, wherein the volumetric region comprises a difference region corresponding to a difference between the segmented object and the modified object.

8. An apparatus according to claim 6, wherein the segmented object is representative of at least part of at least one of an anatomical structure, a pathological structure, an implanted structure.

9. An apparatus according to claim 6, wherein the parameter comprises at least one of a segmentation parameter, a threshold used to define the segmented object, a morphological parameter.

10. An apparatus according to claim 9, wherein the morphological parameter comprises at least one of a dilation parameter, an erosion parameter, a merging parameter, a separation parameter, a morphological open parameter, a morphological close parameter.

11. An apparatus according to claim 1, wherein the parameter comprises a rendering parameter.

12. An apparatus according to claim 11, wherein the rendering parameter comprises at least one of a color, an opacity, a transparency, an absorption.

13. An apparatus according to claim 11, wherein:
the volumetric region comprises at least part of a segmented object representative of at least one of an anatomical structure, a pathological structure, an implanted structure; and
the rendering parameter comprises a rendering parameter of the segmented object.

14. An apparatus according to claim 13, wherein the volumetric region comprises a shell region of the segmented object, the shell region conforming to an outer boundary of the segmented object.

15. An apparatus according to claim 14, wherein the processing circuitry is further configured to obtain the shell region by:
eroding the segmented object to obtain an eroded object; and
subtracting the eroded object from the segmented object to obtain the shell region.

16. An apparatus according to claim 1, wherein the receiving of the changed value for the parameter comprises receiving the changed value for the parameter from a user via a user interface.

17. An apparatus according to claim 16, wherein the receiving of the changed value from the user is in response to the display of the first image.

18. An apparatus according to claim 1, wherein the processing circuitry is further configured to:
generate a third image by re-rendering every pixel of the plurality of the pixels;
obtain a comparison of a time taken to generate the second image and a time taken to generate the third image;
receive a further changed value for the parameter; and
determine based on the comparison whether to generate a further image for the further changed value by re-rendering every pixel or by re-rendering a subset of pixels.

19. An apparatus according to claim 14, wherein the processing circuitry is further configured to:
generate a third image using a further volumetric region, the further volumetric region comprising the entire segmented object;
obtain a comparison of a time taken to generate the second image and a time taken to generate the third image;
receive a further changed value for the parameter; and
determine based on the comparison whether to generate a further image for the further changed value using a volumetric region comprising a shell region or using a volumetric region comprising the entire segmented object.

20. A medical image rendering method comprising:
displaying a first image rendered from a volumetric imaging data set, wherein the first image comprises a plurality of pixels;
receiving a changed value for a parameter associated with a volumetric region of the volumetric imaging data set;
obtaining a subset of the plurality of pixels, the subset comprising pixels corresponding to rays that intersect the volumetric region of the volumetric imaging data set;
re-rendering each pixel of the subset of pixels by casting a respective ray into the volumetric imaging data set using the changed value for the parameter; and
generating a second image in which pixels of the first image that are not part of the subset of pixels are retained, and pixels of the first image that are part of the subset of pixels are replaced by the re-rendered pixels.
